(19) United States
(12) Patent Application Publication
(10) Pub. No.: US 2026/0332928 A1
(43) Pub. Date: Oct. 22, 2026

(54) SLEEP SPEAKER

(71) Applicant: Shenzhen DreamCove Tech Co.,Ltd, Shenzhen (CN)

(72) Inventor: Jianping Wang, Shenzhen (CN)

(21) Appl. No.: 19/707,306

(22) Filed: Jun. 14, 2026

(30) Foreign Application Priority Data
May 14, 2026 (CN) 202620678543.7

(51) Int. Cl. H04R 1/02; F21S 4/28; F21V 15/01; F21V 23/04; F21V 33/00; G04G 13/02; H01M 50/264; H02J 50/00; H02J 50/10

(52) U.S. Cl. CPC H04R 1/028; F21S 4/28; F21V 15/01; F21V 23/04; F21V 33/0056; G04G 13/021; H01M 50/264; H02J 50/005; H02J 50/10; H04R 1/021; H04R 1/023; H04R 1/025; H04R 2420/07

(57) ABSTRACT

Provided is a sleep speaker, which belongs to the technical field of speakers. The sleep speaker includes an upper housing, a lower housing, a front housing, and a rear housing. A main control circuit board, a loudspeaker, and a lithium battery are disposed in a mounting cavity. A top surface of the upper housing is provided with a wireless charging module and a button assembly. A front surface of the front housing is integrated with an atmosphere lamp assembly and a digital tube module. In the present disclosure, the wireless charging module is disposed on a top of the upper housing, and a mobile phone placement boss of a convex structure is adapted to a mobile phone camera protrusion, so as to ensure that a mobile phone is smoothly attached to a charging area, and firmly fix the charging coil by cooperating with a charging coil fixing block.

### TECHNICAL FIELD

The present disclosure relates to the technical field of speakers, and in particular to a sleep speaker.

### BACKGROUND

A sleep speaker is widely used in a bedroom bedside scenario, and is mainly configured to play sleep-assisting audios and set alarm clock reminding, and is a small electronic device commonly used at home. Currently, a conventional sleep speaker on the market is simple in structure and single in function. Most of conventional sleep speakers only have basic Bluetooth play and alarm clock prompt functions, and lack an integrated wireless charging structure of a mobile phone. In daily bedside use, a charger and a data cable are separately required for mobile phone charging, which occupies desktop space and causes messy wiring. In addition, a top surface of a conventional speaker is of a planar structure, and cannot be adapted to a mobile phone with a protruding camera nowadays. After being placed, the mobile phone is prone to tilting and warping, and is low in attachment degree, which affects stability and use experience of wireless charging.

In addition, the conventional sleep speaker has a relatively poor lighting and display design, and an atmosphere lamp is mostly in a single fixed lighting mode, and does not have multi-color switching and a dynamic breathing lamp effect, so that it is difficult to create a comfortable bedtime environment. In addition, a housing splicing structure of an existing product is simple, and problems such as looseness and a large gap easily occur in long-term use. Overall practicality and product experience of the product need to be improved.

### SUMMARY

Embodiments of the present disclosure provide a sleep speaker to solve problems of single function, poor attachment performance for mobile phone wireless charging, simple atmosphere display effect and weak housing assembly stability of existing sleep speakers.

To achieve the foregoing objective, the present disclosure provides a sleep speaker, including an upper housing, a lower housing, a front housing, and a rear housing, where the upper housing, the lower housing, the front housing, and the rear housing encircle an internal mounting cavity, and a main control circuit board, a loudspeaker, and a lithium battery are disposed in the mounting cavity; a top surface of the upper housing is provided with a wireless charging module and a button assembly, a front surface of the front housing is integrated with an atmosphere lamp assembly and a digital tube module, and grid-like holes are formed in a surface of the rear housing; and

the wireless charging module includes a mobile phone placement boss fixedly connected to a top of the upper housing, and a wireless charging coil is mounted in the mobile phone placement boss by using a charging coil fixing block and a screw.

As a preferred embodiment of the present disclosure, a plurality of upper housing studs are fixedly connected inside the upper housing, a clip and an upper housing edge fixing strip are fixedly connected to an edge of the upper housing, and the main control circuit board and the loudspeaker are fixedly mounted in a mounting position formed by the upper housing by using reinforcing ribs.

As a preferred embodiment of the present disclosure, a plurality of lower housing studs are fixedly connected inside the lower housing, a clip slot is formed in an edge of the lower housing, when the lower housing is capped with the upper housing, the upper housing studs are fixedly connected to the lower housing studs by using screws, the clip is connected to the clip slot, a lower housing edge fixing strip is fixedly connected to the edge of the lower housing, a plurality of non-slip mats are fixedly connected to a bottom of the lower housing, a battery mounting base formed by using the reinforcing ribs is further disposed inside the lower housing, and the lithium battery is further mounted in the battery mounting base.

As a preferred embodiment of the present disclosure, the button assembly includes a power button, an atmosphere lamp button, an upper switch button, a SNOOZE button, a lower switch button, a DB (Day Button) button, and an alarm clock button that are mounted on the top of the upper housing, and the power button, the atmosphere lamp button, the upper switch button, the SNOOZE button, the lower switch button, the DB button, and the alarm clock button are electrically connected to the main control circuit board.

As a preferred embodiment of the present disclosure, an edge of the front housing is provided with a front housing pressing groove adapted to the upper housing edge fixing strip and the lower housing edge fixing strip, the atmosphere lamp assembly includes a lamp strip control plate, a lamp strip, and a lamp strip protection cover, the lamp strip is integrated on an outer side of the lamp strip control plate and is embedded in a lamp slot formed in the front surface of the front housing, the lamp strip is electrically connected to the main control circuit board by using the lamp strip control plate, and the lamp strip protection cover covers an outer side of the lamp strip and is snap-fitted with the front housing.

As a preferred embodiment of the present disclosure, a digital tube net cover covers an outer side of the digital tube module, the digital tube net cover is located on an inner side of the lamp strip protection cover and is snap-fitted with the lamp strip protection cover, the digital tube module is electrically connected to the main control circuit board, the main control circuit board is integrated with a Bluetooth module, and the digital tube module is wirelessly connected to an intelligent terminal by using the Bluetooth module.

As a preferred embodiment of the present disclosure, an edge of the rear housing is provided with a rear housing pressing groove adapted to the upper housing edge fixing strip and the lower housing edge fixing strip, and the grid-like holes are opposed to an exhaust position of the loudspeaker.

As a preferred embodiment of the present disclosure, a DC (Direct Current) charging base is disposed on the main control circuit board, and the DC charging base is exposed on the rear housing and electrically connected to the lithium battery.

Compared with the prior art, the present disclosure has the following beneficial effects.

First, in the present disclosure, the wireless charging module is disposed on a top of the upper housing, and a mobile phone placement boss of a convex structure is adapted to a mobile phone camera protrusion, so as to ensure that a mobile phone is smoothly attached to a charging area, and firmly fix the charging coil by cooperating with a charging coil fixing block, thereby improving wireless charging stability and efficiency. In addition, a Bluetooth module integrated in the main control circuit board implements wireless connection to the intelligent terminal. The digital tube module may display a preset pattern in synchronization. The atmosphere lamp module may switch multiple luminous colors and implement a breathing lamp effect, thereby enriching audio-visual interaction experience in a sleep scenario.

Second, in the present disclosure, a dual fixing structure is formed by using the studs and the clip of the upper housing and the studs and the clip slot of the lower housing, and is fitted with extrusion between the upper housing edge fixing strip and the lower housing edge fixing strip by cooperating with the front housing pressing groove and the rear housing pressing groove, thereby greatly improving fastness of housing assembly. The non-slip mats at the bottom of the lower housing effectively enhance stability when the speaker is placed, so as to avoid displacement caused by desktop vibration. The button assembly has a reasonable layout, and integrates functions of a power supply, an atmosphere lamp, track switching, snooze, and an alarm clock. The sleep speaker meets a demand for convenient operation in sleep scenarios, so that the speaker achieves both functional integration and use stability.

### BRIEF DESCRIPTION OF THE DRAWINGS

FIG. 1 is an integral structure diagram according to the present disclosure;

FIG. 2 is one of integral structure diagrams according to the present disclosure;

FIG. 3 is an internal structure diagram according to the present disclosure;

FIG. 4 is one of integral structure diagrams according to the present disclosure;

FIG. 5 is a structure diagram of a lower housing according to the present disclosure;

FIG. 6 is a split diagram according to the present disclosure; and

FIG. 7 is a structure diagram of an upper housing according to the present disclosure.

Reference numerals: 100: upper housing; 101: upper housing stud; 102: clip; 103: upper housing edge fixing strip; 110: wireless charging module; 111: mobile phone placement boss; 112: charging coil fixing block; 113: wireless charging coil; 120: button assembly; 121: power button; 122: atmosphere lamp button; 123: upper switch button; 124: SNOOZE button; 125: lower switch button; 126: DB button; 127: alarm clock button; 200: lower housing; 201: lower housing stud; 202: clip slot; 203: lower housing edge fixing strip; 210: non-slip mat; 220: battery mounting base; 300: front housing; 310: atmosphere lamp assembly; 311: lamp strip control plate; 312: lamp strip; 320: digital tube module; 321: lamp strip protection cover; 322: digital tube net cover; 330: front housing pressing groove; 400: rear housing; 410: grid-like hole; 420: rear housing pressing groove; 500: main control circuit board; 510: DC charging base; 600: loudspeaker; and 700: lithium battery.

### DETAILED DESCRIPTION OF THE EMBODIMENTS

The technical schemes according to embodiments of the present disclosure are clearly and completely described in the following with reference to the drawings in the present disclosure. Apparently, the embodiments in the following description are merely a part rather than all of the embodiments of the present disclosure. Based on the embodiment in the present disclosure, all other embodiments obtained by the ordinary technical staff in the art without contributing creative labor belong to the scope protected by the present disclosure.

### Embodiments

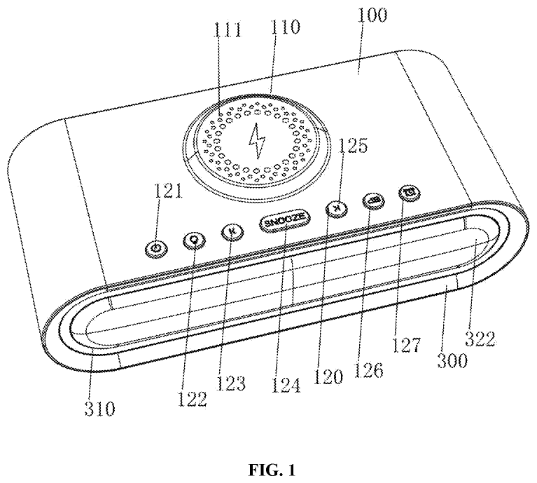

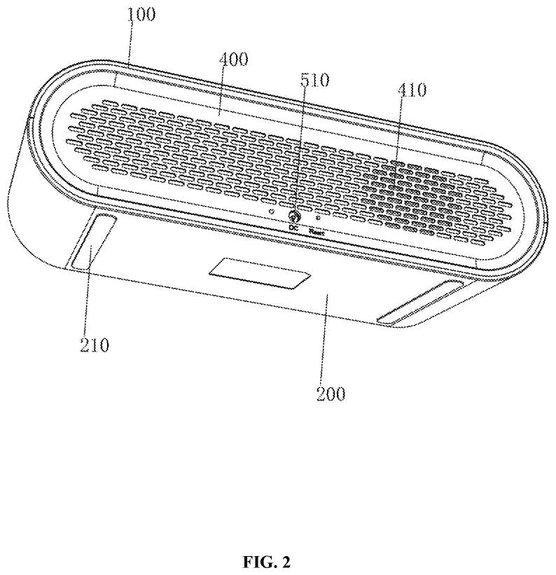

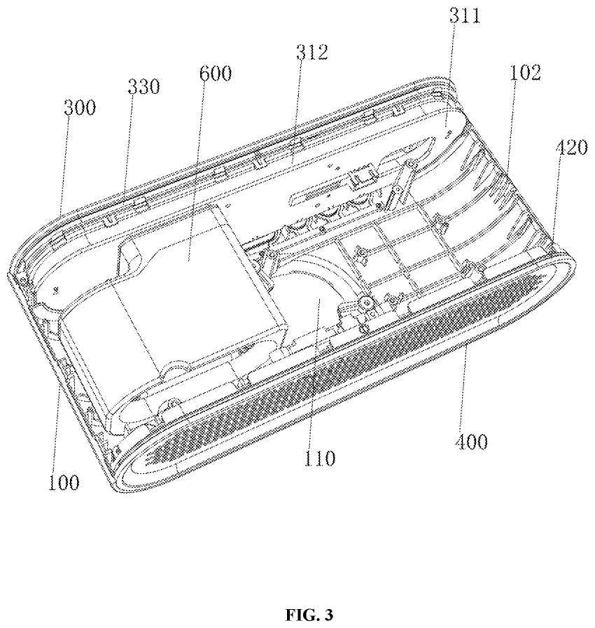

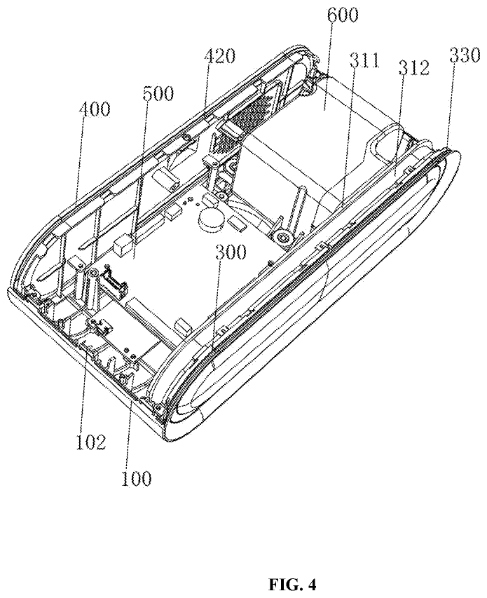

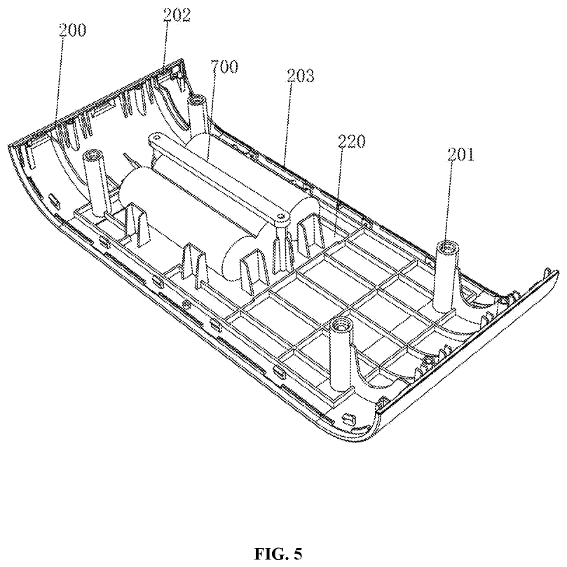

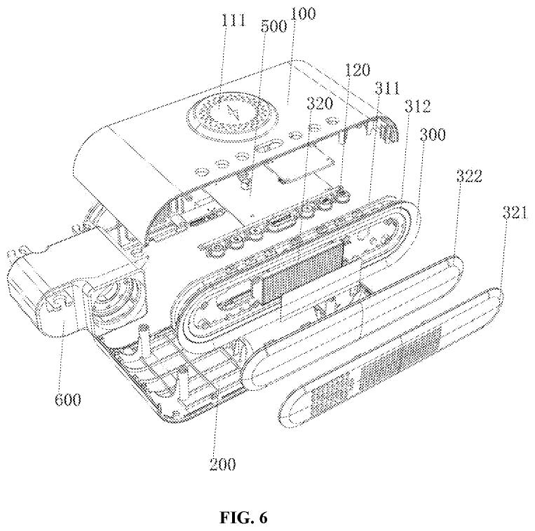

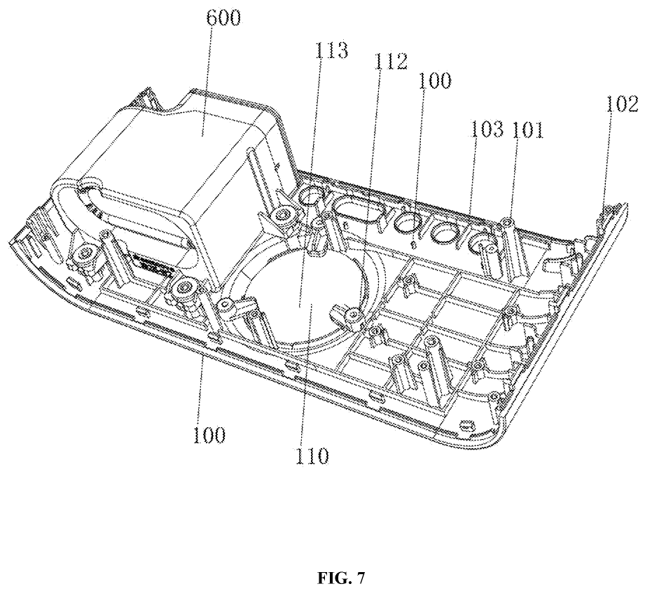

Referring to FIG. 1 to FIG. 7, the present disclosure provides a sleep speaker, including an upper housing 100, a lower housing 200, a front housing 300, and a rear housing 400, where the upper housing 100, the lower housing 200, the front housing (300), and the rear housing 400 encircle an internal mounting cavity, and a main control circuit board 500, a loudspeaker 600, and a lithium battery 700 are disposed in the mounting cavity; a top surface of the upper housing 100 is provided with a wireless charging module 110 and a button assembly 120, a front surface of the front housing 300 is integrated with an atmosphere lamp assembly 310 and a digital tube module 320, and grid-like holes 410 are formed in a surface of the rear housing 400; and

the wireless charging module 110 includes a mobile phone placement boss 111 fixedly connected to a top of the upper housing 100, and a wireless charging coil 113 is mounted in the mobile phone placement boss 111 by using a charging coil fixing block 112 and a screw.

Specifically, in sleep use, a user may place the mobile phone placement boss 111 on the top of the upper housing 100. A protruding structure of the mobile phone placement boss 111 can prevent a mobile phone camera from protruding, so as to ensure that a mobile phone is smoothly attached to a wireless charging area. The wireless charging coil 113 is firmly fixed to an inner side of the upper housing 100 by using the charging coil fixing block 112, and is electrically connected to the main control circuit board 500 to implement stable wireless charging. In addition, the user may enable an audio play function by using the button assembly 120, and the grid-like holes 410 may balance air pressure of the loudspeaker 600, optimize sound quality, protect a diaphragm, and assist heat dissipation.

The atmosphere lamp assembly 310 can provide soft lighting, and the digital tube module 320 can display related information, so that the speaker is integrated with charging, audio, lighting, and display functions, and adapts to diversified demands of sleep scenarios.

In this embodiment, a plurality of upper housing studs 101 are fixedly connected inside the upper housing 100, a clip 102 and an upper housing edge fixing strip 103 are fixedly connected to an edge of the upper housing 100, and the main control circuit board 500 and the loudspeaker 600 are fixedly mounted in a mounting position formed by the upper housing 100 by using reinforcing ribs.

Specifically, the upper housing 100 forms an independent mounting position by using the internal reinforcing ribs, so that the main control circuit board 500 and the loudspeaker 600 can be stably mounted, thereby avoiding component displacement due to vibration during use. The upper housing studs 101 are configured to cooperate with studs of the lower housing 200 to implement screw fixation, and the clip 102 is configured to be snap-fitted with the clip slot 202 of the lower housing 200. A dual fixing structure improves fastness of a connection between the upper housing 100 and the lower housing 200. The upper housing edge fixing strip 103 may provide positioning and pressing functions for assembling the front housing 300 and the rear housing 400, so as to ensure sealing and stability of the whole housing structure.

In this embodiment, a plurality of lower housing studs 201 are fixedly connected inside the lower housing 200, a clip slot 202 is formed in an edge of the lower housing 200, when the lower housing 200 is capped with the upper housing 100, the upper housing studs 101 are fixedly connected to the lower housing studs 201 by using screws, the clip 102 is snap-fitted with the clip slot 202, a lower housing edge fixing strip 203 is fixedly connected to the edge of the lower housing 200, a plurality of non-slip mats 210 are fixedly connected to a bottom of the lower housing 200, a battery mounting base 220 formed by using the reinforcing ribs is further disposed inside the lower housing 200, and the lithium battery 700 is further mounted in the battery mounting base 220.

Specifically, when the upper housing 100 is capped with the lower housing 200, the upper housing studs 101 are aligned with the lower housing studs 201 and then locked by screws, and the clip 102 is snap-fitted into the clip slot 202 to form a dual connection structure in which the screw is fixedly snap-fitted with the clip 102, thereby effectively preventing loosening of the housing after long-term use. The lower housing edge fixing strip 203 cooperates with the upper housing edge fixing strip 103 to form extrusion fixation to edges of the front housing 300 and the rear housing 400, so as to improve overall assembling tightness. The non-slip mats 210 at the bottom of the lower housing 200 increase friction with a placement surface, and avoids speaker displacement during desktop vibration. The battery mounting base 220 is integrally formed by using the reinforcing ribs, so as to provide solid mounting space for the lithium battery 700 and ensure power supply stability.

In this embodiment, the button assembly 120 includes a power button 121, an atmosphere lamp button 122, an upper switch button 123, a SNOOZE button 124, a lower switch button 125, a DB (Day Button) button 126, and an alarm clock button 127 that are mounted on the top of the upper housing 100, and the power button 121, the atmosphere lamp button 122, the upper switch button 123, the SNOOZE button 124, the lower switch button 125, the DB button 126, and the alarm clock button 127 are electrically connected to the main control circuit board 500.

Specifically, the user may control the speaker to be switched and off by using the power button 121. The atmosphere lamp button 122 is configured to switch color, brightness, and breathing mode of the atmosphere lamp, and is adapted to a lighting requirement during sleep. The upper switch button 123 and the lower switch button 125 are configured to adjust a volume size or switch audio tracks. The SNOOZE button 124 can implement an alarm clock snooze function to meet a requirement of staying in bed for the user. The DB button 126 may trigger a specific sound effect mode. The alarm clock button 127 is configured to set, enable, or disable an alarm clock function. All buttons are directly connected to the main control circuit board 500. The operation responds quickly, and the layout is reasonable and easy to recognize, so as to facilitate a blind operation in a night sleep scenario.

In this embodiment, an edge of the front housing 300 is provided with a front housing pressing groove 330 adapted to the upper housing edge fixing strip 103 and the lower housing edge fixing strip 203, the atmosphere lamp assembly 310 includes a lamp strip control plate 311, a lamp strip 312, and a lamp strip protection cover 321, the lamp strip 312 is integrated on an outer side of the lamp strip control plate 311 and is embedded in a lamp slot formed in the front surface of the front housing 300, the lamp strip 312 is electrically connected to the main control circuit board 500 by using the lamp strip control plate 311, and the lamp strip protection cover 321 covers an outer side of the lamp strip 312 and is snap-fitted with the front housing 300.

Specifically, the front housing 300 is fitted with extrusion between the upper housing edge fixing strip 103 and the lower housing edge fixing strip 203 by using the front housing pressing groove 330 on the edge, so as to implement firm assembly. The lamp strip 312 is integrated onto the lamp strip control plate 311, and the lamp strip control plate 311 receives a control signal of the main control circuit board 500, so as to implement color switching, brightness adjustment, and a breathing lamp effect of the lamp strip 312, thereby creating a soft atmosphere for a sleep scenario. The lamp strip protection cover 321 is disposed to protect the lamp strip 312 from dust and collision damage, and enable light to be evenly scattered, thereby improving a lighting effect.

In this embodiment, a digital tube net cover 322 covers an outer side of the digital tube module 320, the digital tube net cover 322 is located on an inner side of the lamp strip protection cover 321 and is snap-fitted with the lamp strip protection cover, the digital tube module 320 is electrically connected to the main control circuit board 500, the main control circuit board 500 is integrated with a Bluetooth module, and the digital tube module 320 is wirelessly connected to an intelligent terminal by using the Bluetooth module.

Specifically, the user may connect to the intelligent terminal such as the mobile phone by using Bluetooth. The user can not only wirelessly play sleep music, but also control the digital tube module 320 by using the terminal, so as to display a preset pattern. The digital tube net cover 322 forms protection against the digital tube module 320, and a service life is prolonged, so that audio interaction is stronger, and the sleep speaker is more compatible with a use requirement of a young user.

In this embodiment, an edge of the rear housing 400 is provided with a rear housing pressing groove 420 adapted to the upper housing edge fixing strip 103 and the lower housing edge fixing strip 203, and the grid-like holes 410 are opposed to an exhaust position of the loudspeaker 600.

Specifically, the rear housing 400 is in pressing fit with the upper housing 100 and the lower housing 200 by using the rear housing pressing groove 420, so as to effectively ensure sealing. The grid-like holes 410 may balance air pressure of the loudspeaker 600, optimize sound quality, protect a diaphragm, and assist heat dissipation. In addition, a grid structure can prevent dust from entering an interior of a machine body, thereby effectively protecting a sound emitting component, and prolonging a service life of the device.

In this embodiment, a DC (Direct Current) charging base 510 is disposed on the main control circuit board 500, and the DC charging base 510 is exposed on the rear housing 400 and electrically connected to the lithium battery 700.

Specifically, a power supply can be conveniently connected into the DC charging base 510 exposed on an outer side of the rear housing 400, so as to recharge the internal lithium battery 700. The built-in lithium battery 700 can also be independently used from a power cable, and is disposed without being limited by a socket position, so that bedside placement is more flexible and convenient.

It needs to be noted that in this specification, relational terms such as “first” and “second” are only used to distinguish one entity or operation from another, and do not necessarily require or imply that any actual relationship or sequence exists between these entities or operations. Moreover, the terms “include”, “contain”, or any other variants are intended to cover a non-exclusive inclusion, so that a process, a method, an article, or a device that includes a list of elements not only includes those elements but also includes other elements that are not expressly listed, or further includes elements inherent to such a process, method, article, or device.

Although the embodiments of the present disclosure have already been illustrated and described, various changes, modifications, replacements and transformations can be made by those skilled in the art under the condition of without departing from the principle and the spirit of the present disclosure, and thus the scope of the present disclosure should be restricted by claims and equivalents thereof.

What is claimed is:

1. A sleep speaker, comprising an upper housing (100), a lower housing (200), a front housing (300), and a rear housing (400), wherein the upper housing (100), the lower housing (200), the front housing (300), and the rear housing (400) encircle an internal mounting cavity, and a main control circuit board (500), a loudspeaker (600), and a lithium battery (700) are disposed in the mounting cavity; a top surface of the upper housing (100) is provided with a wireless charging module (110) and a button assembly (120), a front surface of the front housing (300) is integrated with an atmosphere lamp assembly (310) and a digital tube module (320), and grid-like holes (410) are formed in a surface of the rear housing (400); and
the wireless charging module (110) comprises a mobile phone placement boss (111) fixedly connected to a top of the upper housing (100), and a wireless charging coil (113) is mounted in the mobile phone placement boss (111) by using a charging coil fixing block (112) and a screw.

2. The sleep speaker according to claim 1, wherein a plurality of upper housing studs (101) are fixedly connected inside the upper housing (100), a clip (102) and an upper housing edge fixing strip (103) are fixedly connected to an edge of the upper housing (100), and the main control circuit board (500) and the loudspeaker (600) are fixedly mounted in a mounting position formed by the upper housing (100) by using reinforcing ribs.

3. The sleep speaker according to claim 2, wherein a plurality of lower housing studs (201) are fixedly connected inside the lower housing (200), a clip slot (202) is formed in an edge of the lower housing (200), when the lower housing (200) is capped with the upper housing (100), the upper housing studs (101) are fixedly connected to the lower housing studs (201) by using screws, the clip (102) is connected to the clip slot (202), a lower housing edge fixing strip (203) is fixedly connected to the edge of the lower housing (200), a plurality of non-slip mats (210) are fixedly connected to a bottom of the lower housing (200), a battery mounting base (220) formed by using the reinforcing ribs is further disposed inside the lower housing (200), and the lithium battery (700) is further mounted in the battery mounting base (220).

4. The sleep speaker according to claim 1, wherein the button assembly (120) comprises a power button (121), an atmosphere lamp button (122), an upper switch button (123), a SNOOZE button (124), a lower switch button (125), a DB (Day Button) button (126), and an alarm clock button (127) that are mounted on the top of the upper housing (100), and the power button (121), the atmosphere lamp button (122), the upper switch button (123), the SNOOZE button (124), the lower switch button (125), the DB button (126), and the alarm clock button (127) are electrically connected to the main control circuit board (500).

5. The sleep speaker according to claim 3, wherein an edge of the front housing (300) is provided with a front housing pressing groove (330) adapted to the upper housing edge fixing strip (103) and the lower housing edge fixing strip (203), the atmosphere lamp assembly (310) comprises a lamp strip control plate (311), a lamp strip (312), and a lamp strip protection cover (321), the lamp strip (312) is integrated on an outer side of the lamp strip control plate (311) and is embedded in a lamp slot formed in the front surface of the front housing (300), the lamp strip (312) is electrically connected to the main control circuit board (500) by using the lamp strip control plate (311), and the lamp strip protection cover (321) covers an outer side of the lamp strip (312) and is snap-fitted with the front housing (300).

6. The sleep speaker according to claim 5, wherein a digital tube net cover (322) covers an outer side of the digital tube module (320), the digital tube net cover (322) is located on an inner side of the lamp strip protection cover (321) and is snap-fitted with the lamp strip protection cover, the digital tube module (320) is electrically connected to the main control circuit board (500), the main control circuit board (500) is integrated with a Bluetooth module, and the digital tube module (320) is wirelessly connected to an intelligent terminal by using the Bluetooth module.

7. The sleep speaker according to claim 5, wherein an edge of the rear housing (400) is provided with a rear housing pressing groove (420) adapted to the upper housing edge fixing strip (103) and the lower housing edge fixing strip (203), and the grid-like holes (410) are opposed to an exhaust position of the loudspeaker (600).

8. The sleep speaker according to claim 1, wherein a DC (Direct Current) charging base (510) is disposed on the main control circuit board (500), and the DC charging base (510) is exposed on the rear housing (400) and electrically connected to the lithium battery (700).
